(19) United States
(12) Patent Application Publication
(10) Pub. No.: US 2008/0127176 A1
(43) Pub. Date: May 29, 2008

(54) METHOD AND APPARATUS FOR MANAGING BLOG INFORMATION

(75) Inventors: Dae-hyun Lee, Seoul (KR); Chang-nam Chu, Yongin-si (KR); Chun-un Kang, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd, Suwon-si (KR)

(21) Appl. No.: 11/830,932

(22) Filed: Jul. 31, 2007

(30) Foreign Application Priority Data
Nov. 29, 2006 (KR) 2006-119308

(51) Int. Cl. G06F 17/30; G06F 9/445

(52) U.S. Cl. 717/174; 707/1; 707/E17.001

(57) ABSTRACT

A method and apparatus for managing blog information. The blog information managing device includes a blog information managing module to manage blog information about content and a loading module to read out the blog information and to upload the content to a website according to the blog information.

### CROSS-REFERENCE TO RELATED APPLICATION

This application claims the benefit of Korean Patent Application No. 2006-119308, filed in the Korean Intellectual Property Office on Nov. 29, 2006, the disclosure of which is incorporated herein by reference.

### BACKGROUND OF THE INVENTION

1. Field of the Invention

Aspects of the present invention relate to a method and apparatus for managing blog information and, more particularly, to a method and apparatus for managing blog information, including managing blog information and uploading the content to a website according to the blog information when the user's device is connected to a target device.

2. Description of the Related Art

Blog (short for “web log”) sites, where a user uploads and shares writing, images, videos (hereinafter, referred to as “content”), have become popular. Blog sites are web sites that display. content updated by users according to their interests. Users can upload images or videos captured by a mobile device, such as a digital camera, a digital camcorder, a voice recorder, and a camera phone, in addition to uploading other types of content, such as text, from other sources.

FIG. 1 is a conceptual diagram illustrating how content is uploaded on a blog site through a conventional mobile device. The user connects a mobile device to their PC through USB, and transmits pictures and videos to the PC in operation S11. Software (first software) that is compatible with the mobile device is installed in the PC for editing the content stored in the PC. For example, the user can edit the images by applying a frame effect or other effects to the images. The first software is unavailable in the blog site because the first software is not connected with the blog site.

The user re-uploads the content stored in the PC to the blog site in operation S21. For example, the user uploads the captured videos to a video menu. Software (second software) connected with the blog site is installed to edit content properly or to control the size of the uploaded content. The user can log-in to the blog site automatically through the stored log-in information. However, when using a shared PC (for example, an office PC, or PCs in public libraries, computer labs, or Internet cafes), the log-in information cannot be stored (so as to maintain privacy) and the log in function is unavailable.

The user cannot upload the content stored in the mobile device to the blog site when the PC is off. These complicated processes are unavoidable until all the content is uploaded.

### SUMMARY OF THE INVENTION

Aspects of the present invention provide a method and apparatus for managing blog information, the method including managing blog information by content, and uploading the content on a website according to the blog information when the user's device is connected to the target device.

Additional aspects of the present invention enable a user's device to easily connect to a website through automatic log in to the website without inputting user information when connected to the device.

Other aspects of the present invention provide a dynamic session so that the content stored in the user's device can be backed up to a remote server.

According to an aspect of the present invention, an apparatus to manage blog information is provided. The apparatus includes a blog information managing module to manage blog information about content without requiring a connection to a website to which the content is to be uploaded, and a loading module to read out the blog information and to upload the content to a website according to the blog information.

According to another aspect of the present invention, a method of managing blog information is provided. The method includes managing blog information relating to content, reading the blog information, and uploading the content to the website according to the blog information.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a conceptual diagram illustrating how content is uploaded to a blog site through a conventional mobile device;

FIG. 2 is a block diagram of a blog information managing device according to an embodiment of the present invention;

FIG. 3 is a flowchart of management of blog information according to an embodiment of the present invention;

FIG. 4 illustrates an example of a set screen according to an embodiment of the present invention;

FIG. 5 is a conceptual diagram of blog registration according to an embodiment of the present invention; and

FIG. 6 is a conceptual diagram of blog registration according to another embodiment of the present invention.

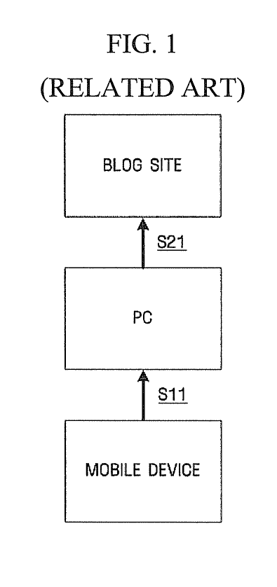

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

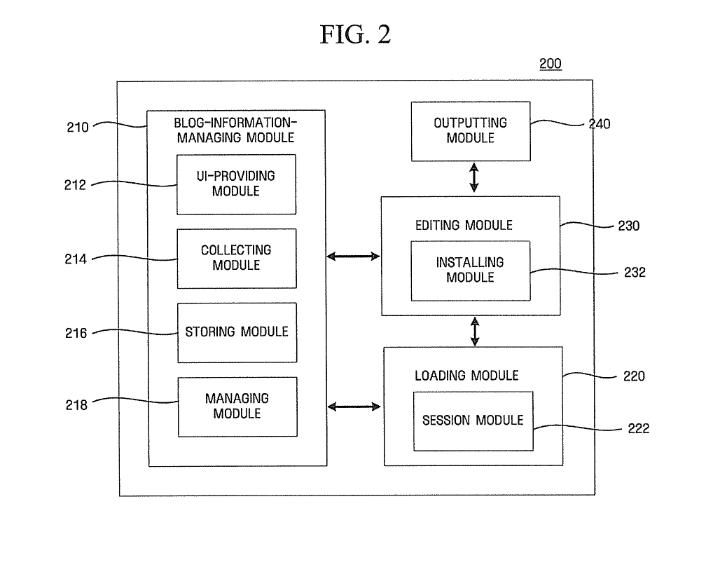

FIG. 2 is a block diagram of a blog information managing device 200 according to an embodiment of the present invention. The blog information managing device 200 includes a blog information management module 210, a loading module 220, an editing module 230, and an outputting module 240. The blog information managing device 200 according to other aspects of the invention may include different modules; similarly, one or more of the above modules may be combined into a single component. The blog information managing device 200 can be embodied by a digital camera, a digital camcorder, a voice recorder, a camera mobile phone, personal digital assistant, personal entertainment device, and/or a mobile device. Other aspects of the present invention may apply the concepts described herein with respect to blog sites to other types of web sites. Similarly, although described with respect to blog information, other aspects of the present invention may apply the concepts described herein to managing other types of information used to access and/or interact with web sites.

The blog information management module 210 manages the blog information with respect to the content to be uploaded to the blog site. The blog information includes content type, content size, significance of the content, privacy settings (e.g., private, public, or friends only), menu title, information on each blog site (e.g., website information and site name if a plurality of blog sites are used), and information on the date/time new content was generated or uploaded to the blog site. The blog information may include user information and information on photo-editing effects. The information on the photo-editing effect is setting information that the user will use for predetermined content. For example, when a user applies a photo-decorating effect or a black and white photo-editing effect for an image on a screen provided through a UI-providing module 212, the corresponding setting information can be stored as information on photo-editing effects. The user information includes information on a user ID and a password, and information identifying mobile devices. The blog information also includes various information set or input from the UI-providing module 212. The user ID and the password are referred to as user information.

The blog information management module 210 includes a UI-providing module 212, a collecting module 214, a storing module 216, and a management module 218. The UI-providing module 212 provides a screen for setting blog information on the content. For example, the UI-providing module 212 may provide a screen for setting the photo-editing effect frequently used by the user. The UI-providing module 212 also provides a screen for managing blog information (for example, deleting, adding, and updating blog information). The user can select a blog site for uploading content on a screen provided by the UI-providing module 212 or set a variety of rules, such as content to be uploaded, photo-editing effects to be applied to the content, menus of the blog site, etc. When the collecting module 214 collects information on the content uploaded to a blog site and sends the information to the UI-providing module 212, the UI-providing module 212 indicates the content that has been already uploaded to distinguish the content already uploaded from other content on the screen. The user can easily determine which content should be deleted if the storage capacity of the blog information managing device 200 is inadequate. The information set through a set screen provided by the UI-providing module 212 is stored in the blog information.

The collecting module 214 collects the blog information. The collecting module 214 collects the blog information from a server that provides blog sites or from the information input by the users through the set screen provided by the UI-providing module 212. The blog information also can be collected from event information about events generated in a user mobile device. The event information includes information on the date/time new content was generated in a mobile device or was uploaded to the blog site from the blog information managing device 200.

The storing module 216 stores blog information collected from the collecting module 214. The management module 218 manages the blog information, including deleting, upgrading, and adding the stored blog information. For example, the information on new content collected from the collecting module 214 can be additionally stored in the storing module 216, or the previously stored content can be deleted. The management module 218 can manage the blog information through the managing screen provided by the UI-providing module 212. The user can check the blog information in a device while disconnected from the Internet, edit the content through the blog information management module 210, or perform the work for uploading the content to the blog site in advance.

The loading module 220 reads out the blog information stored in the storing module 216, and uploads the content to the blog site according to the blog information. If the blog information managing device 200 tries to connect to the blog site wirelessly, an automatic log-in is made to the blog site through a session module 222, and the loading module 220 may upload the content to the blog site according to the blog information. If the user connects the blog information managing device 200 to a target device (such as a shared or private PC), the session module 222 may perform automatic log-in to the blog site by creating a dynamic session with the target device. The loading module 220 uploads the content to the blog site. The target device acts as a bridge for connecting the blog information managing device 200 and the blog site. The target device may be a shared PC, private (not shared) PC, a set top box, or other device. The loading module 220 may upload the content to the blog site according to the information set in the blog information. For example, the loading module 220 reads the information on the content that was already uploaded to the blog site, and uploads only the content that is not yet uploaded. The loading module 220 may select and upload only the content that is not yet uploaded through the time-related information collected by the collecting module 214. The time-related information includes the information on the date/time the content was generated and uploaded. The content may be edited by an editing module 230 when the content is uploaded.

The loading module 220 may include a session module 222. The session module 222 is able to perform automatic log-in to or log-out from the blog site by creating a dynamic session with the target device when the user connects a mobile device to the target device. The session module 222 creates the session using an identification number of the blog information management device 200. The target device can check the identification number of the mobile device and permit the automatic log-in of the user through a module for creating the session with the session module 222. Inconvenience caused by inputting user information for every set of content when the user uploads content to the blog site can be overcome. In addition, the problem of storing user information for preventing information leakage when using a shared PC can be solved. The session module 222 may permit the automatic log-in or log-out using the user information other than the identification number of the mobile device. The automatic log-out may be performed when the user disconnects the blog information management device 200 from the target device. The automatic log-in may be set in a screen provided by the UI-providing module 212.

The editing module 230 edits the content according to the photo-editing effect set by the user, or provides a tool so that the user can directly edit the content. The editing module 230 may also perform other editing of the content, depending on the type of content; for example, if the content is text, the editing module may perform word processing, spell checking, grammar checking, etc., on the content. If the user sets his or her favorite photo-editing effect through the set screen provided by the UI-providing module 212, the editing module 230 edits the content according to the input information. The user may set the photo-editing effect for the content through the UI-providing module 212 or for each blog site. When the photo-editing effect desired by the user is set for each blog site, the photo-editing effect collectively set for the content uploaded to the corresponding blog site can be applied. The editing module 230 combines two or more of text, image, video, and audio content, and edits the combined content as complex media. The editing module 230 may perform real-time editing of the content when the content is uploaded through the loading module 220.

The editing module 230 may include an installing module 232. The installing module 232 installs and deletes a predetermined module that the user uses to edit the content. In the past, first software compatible with the user's mobile device was installed in the PC, and the user edited the content using the first software. The content was also edited using second software compatible with a blog site. However, for shared PCs, the photo-editing effect had to be installed. The installing module 232 instead installs a module including the photo-editing effect set in the blog information management device 200 in advance by the user. The photo-editing effect set by the user in the blog information management device 200 can be directly applied to the content through the module in the target device (e.g., the shared PC). The module installed in the targeted object may be automatically deleted when the user disconnects the mobile device from the target device. A deletion function may be executed when the installed module instructs the corresponding device, or the deletion function may be executed through a predetermined function in the installed module. The deletion or installation of modules through the installing module 232 may be executed when the photo-editing effect is not set in the screen of the UI-providing module 212 and the user wants to edit the content in the target device.

The outputting module 240 displays the blog information on a screen, or provides information to the user on how much present content is uploaded by the loading module 220. The outputting module 240 may indicate the user's blog sites on a screen when uploading the content. When content uploading is completed, a predetermined message is displayed on a screen to inform the user.

The term “module” as used herein indicates, but is not limited to, a software or hardware component, such as a Field Programmable Gate Array (FPGA) or an Application Specific Integrated Circuit (ASIC), that performs certain tasks. A module may advantageously be configured to reside on an addressable storage medium and to execute on one or more processors. Thus, a “module” may include, by way of example, components, such as software components, object-oriented software components, class components and task components, process, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

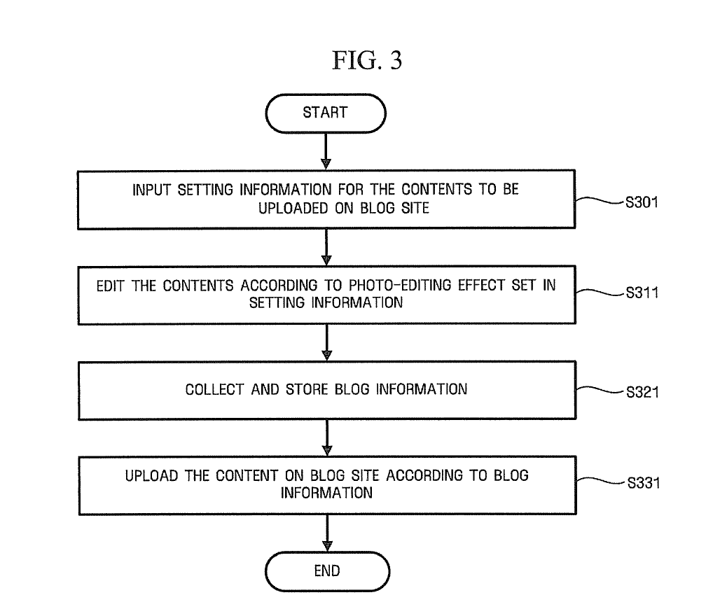

FIG. 3 is a flowchart of management of blog information according to an embodiment of the present invention. In operation S301, the user inputs the setting information with respect to the content to be uploaded on a blog site (website) through a screen provided by the UI-providing module 212. For example, the user may select a blog site to upload content to or set the photo-editing effect to be applied to the content. The input setting information can be included in the blog information.

In operation S311, the editing module 230 edits the content according to the photo-editing effect set in the setting information. The editing module 230 may edit the content based on additional setting information input by the user. Editing content according to the set photo-editing effect may be performed when the content is uploaded to a predetermined blog site.

In operation S321, the collecting module 214 collects the blog information through the information input by the UI-providing module 212, and stores the blog information in the storing module 216. The collecting module 214 may collect blog information from the blog information management device 200 in which a predetermined event occurred. The collecting module 214 may collect information such as the address of the blog site, menus provided by each blog site, and privacy settings in the blog site from a server providing the blog site.

In operation S331, when the user connects the blog information management device 200 to the target device, the loading module 220 reads the stored blog information and uploads the content to the blog site. The session module 222 is able to perform automatic log-in to or log-out from the blog site by creating the dynamic session with the target device when the user connects the blog information management device 200 to the target device. The content that was previously edited in the blog information management device 200 may be uploaded to the blog site through the loading module 220 by simply connecting the mobile device to the targeted object. If the mobile device is connected to a blog site wirelessly, the automatic log-in to the blog site is performed through the session module 222, and the content can be uploaded to the blog site through the loading module 220 according to the blog information.

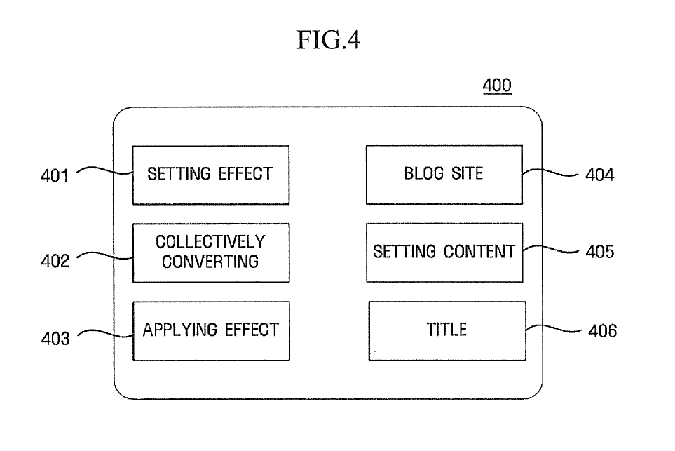

FIG. 4 illustrates an example of a set screen according to an embodiment of the present invention. The user may set the photo-editing effect to be applied to the content in a photo-editing effect setting menu 401 of a set screen 400 provided by the UI-providing module 212. Photo-editing effects that are frequently used by the user, such as decoration, picture frame, and icon, can be set. Whether the photo-editing effect set in a collective conversion menu 402 should be collectively applied to content to be uploaded may also be set. The user may apply or cancel the photo-editing effect set in a photo-editing effect applying menu 403. Although described with respect to a photo-editing effect, the effect setting menu 401, collective conversion menu 402, and effect applying menu 403 may be applied to any editing effect selected by the user.

The user may select blog sites to which the content is to be uploaded in a blog site menu 404. For example, when the Naver and Daum blog sites (popular South Korean websites) are selected, content to be uploaded is uploaded to a plurality of sites. The user can select content to be uploaded in a content-setting menu 405. The content to be uploaded has already been selected using the time-related information of the uploaded content in advance and the newly generated content.

The menu title of the blog site for uploading content can be set in a title menu 406. For example, when a title is set as a video, the content is uploaded to a video menu of the blog site set in the blog site menu 404. The privacy settings in the blog site (e.g., private, public, or friends only), the automatic log-in through the session module 222, and a variety of setting menus, except for the provided setting menus (401 to 406), can be provided. The information shown in FIG. 4 is included in the blog information and stored in a database. The user may set blog information on the content or edit the content in a mobile device in advance without connecting to a blog site.

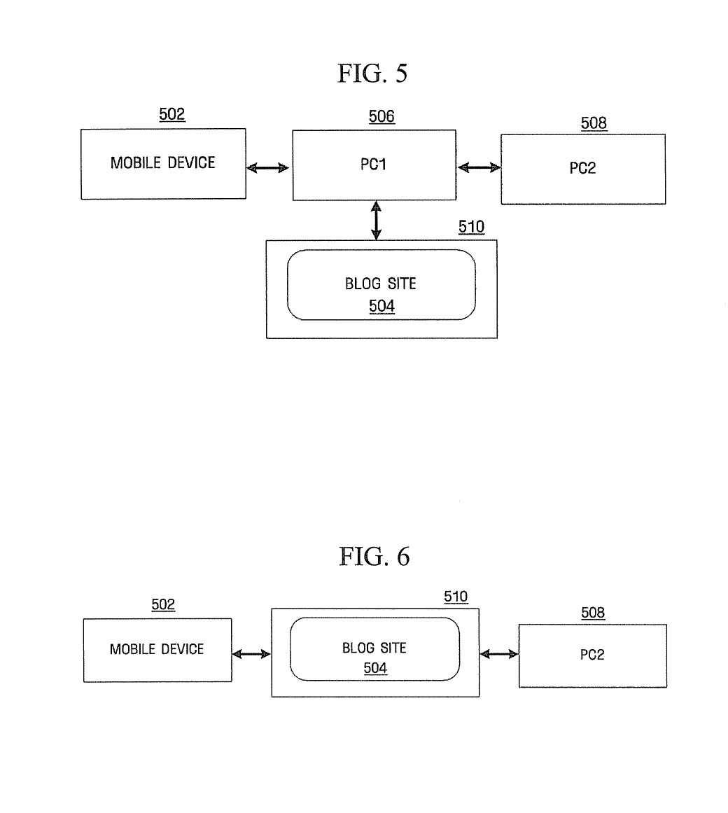

FIG. 5 is a conceptual diagram of blog registration according to an embodiment of the present invention. When a user connects a mobile device 502 to a PC 1 506 in the office, automatic log-in is performed through the session module 222 between the PC 1 506 and the blog site. The content is uploaded to the blog site (website) 504 through the loading module 220. With “Plug & Blog”, the content can be automatically uploaded to the corresponding blog site according to the blog information set in the mobile device 502 without any additional log-in process. A plurality of blog sites may be set in the set screen of the mobile device. When the photo-editing effects are set differently according to each blog site, the photo-editing effects corresponding to the content to be uploaded to each blog site are applied.

The session module 222 can back-up the content to a remote PC2 508 (e.g., a home PC). A predetermined module for creating the dynamic session with the session module 222 can be installed in advance in a server 510 that provides PC 2 508 and a blog site 504. The session module 222 creates the session with a module installed in the server 510, creates another session with a module installed in PC 2 508, and backs up the content to PC 2 508. The session module 222 can create the session using a module installed in the server 510, a module installed in the PC 2 508, an identification number of the user's device, or user information.

FIG. 6 is a conceptual diagram of blog registration according to another embodiment of the present invention. When the mobile device 502 tries to connect to the blog site 504 wirelessly, the automatic log-in to the blog site 504 is performed through the session module 222, and the content is directly uploaded to the blog site 504 through the session module 222 according to the blog information.

The method and apparatus for managing blog information according to aspects of the present invention produce several effects. First, the blog information of the content can be managed anywhere at any time in a user's device that cannot be directly connected to a blog site through the Internet. Second, the content can be directly uploaded to a website based on the blog information of the user's device by connecting the user's device to a PC using a “Plug & Blog” technique. Third, the blog information (or content) stored in the user's device can be backed up to a remote server.

Blog information management techniques according to aspects of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CDs and DVDs; magneto-optical media such as optical disks; and hardware devices that are specially configured to store and perform program instructions, such as read-only memory (ROM), random access memory (RAM), flash memory, and the like; and a computer data signal embodied in a carrier wave comprising a compression source code segment and an encryption source code segment (such as data transmission through the Internet). The computer readable recording medium can also be distributed over network coupled computer systems so that the computer readable code is stored and executed in a distributed fashion. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An apparatus to manage blog information, the apparatus comprising:
a blog information managing module to manage blog information about content without requiring a connection to a website to which the content is to be uploaded; and
a loading module to read the blog information and to upload the content to the website according to the blog information.

2. The apparatus of claim 1, further comprising a photo-editing module to edit the content according to a photo-editing effect set by a user.

3. The apparatus of claim 2, wherein the photo-editing module comprises an installing module to install and delete a predetermined module used to edit the content on a target device.

4. The apparatus of claim 3, wherein the installing module installs the module in the target device when the apparatus is connected to the target device, and deletes the module when the apparatus is disconnected from the target device.

5. The apparatus of claim 1, wherein the blog information comprises one or more of content type, content size, privacy settings in the website, menu title, information on a time the content was uploaded to the website, information on the photo-editing effect set for the content, and user information.

6. The apparatus of claim 5, wherein the user information comprises one or more of a user's ID, password, and identification information of the user's device.

7. The apparatus of claim 1, wherein the loading module comprises a session module to automatically log-in to and log-out from the website.

8. The apparatus of claim 7, wherein the session module performs the automatic log-in using the identification number of the apparatus.

9. The apparatus of claim 1, wherein the blog information managing module comprises:
a UI-providing module to provide a screen to input setting information;
a collecting module to collect the blog information based on the setting information; and
a storing module to store the collected blog information.

10. The apparatus of claim 1, wherein the loading module selects and uploads the content to be uploaded to the website.

11. The apparatus of claim 9, wherein the setting information comprises one or more of information on the website, a photo-editing effect to be applied to the content, and content to be uploaded.

12. A method of managing blog information, the method comprising:
managing blog information relating to content without requiring a connection to a website to which the content is to be uploaded; and
reading the blog information and uploading the content to a website according to the blog information.

13. The method of claim 12, further comprising editing the content according to a photo-editing effect set by a user.

14. The method of claim 13, wherein the editing of the content comprises installing and deleting a predetermined module used to edit the content on a target device.

15. The method of claim 14, wherein the installing process comprises:
installing the predetermined module in the target device when a user's device is connected to the targeted object; and
deleting the predetermined module when the user's device is disconnected from the target device.

16. The method of claim 12, wherein the blog information comprises one or more of content type, content size, privacy settings for the website, menu title, information on a time the content is uploaded to the website, information on the photo-editing effect set for the content, and user information.

17. The method of claim 16, wherein the user information comprises one or more of the user's ID, password, and identification information of the user's device.

18. The method of claim 12, wherein the uploading of the content comprises automatically logging in to the website.

19. The method of claim 18, wherein the automatically logging-in comprises automatically logging-in to the website using the identification number of a user's device.

20. The method of claim 12, wherein the managing of the blog information comprises:
providing a screen for inputting setting information;
collecting the blog information based on the setting information; and
storing the collected blog information.

21. The method of claim 12, wherein the uploading of the content comprises selecting and uploading the content to be uploaded to the website.

22. The method of claim 20, wherein the setting information comprises one or more of information on the website, a photo-editing effect to be applied to the content, and content to be uploaded.

23. The apparatus of claim 9, wherein the blog information managing module further comprises:
a management module to manage the blog information by adding, deleting, and/or updating the blog information, based on the setting information.

24. An apparatus to manage blog information and content, the apparatus comprising:
an editing module to edit content to be uploaded to a blog site;
a blog information management module to manage blog information about the blog site with respect to the content, without requiring a connection to the blog site;
a loading unit to communicate with the blog site so as to download the blog information from the blog site and to upload the content and/or the managed blog information to the blog site.

25. The apparatus of claim 24, wherein the blog information management module comprises:
a user interface module to provide a user interface to a user so as to allow the user to input setting information about the blog information and the content;
a collecting module to collect the blog information from the user and/or the blog site;
a storage module to store the content and the blog information; and
a managing module to control the user interface module, collecting module, and storage module based on the setting information input by the user via the user interface module.

26. The apparatus of claim 24, wherein the editing module comprises an installing module to install a predetermined module on a target device when the apparatus is connected to the target device and to uninstall the predetermined module from the target device when the apparatus is disconnected from the target device;
wherein the predetermined module enables the user to edit the content using the target device.

27. The apparatus of claim 24, further comprising:
a session module to create a dynamic session with the blog site so as to automatically log-in to and log-out from the blog site.

28. The apparatus of claim 27, wherein the session module automatically backs up the content to a remote server.

29. A method of interacting with a blog site via a target device, the method comprising:
editing content without requiring a connection to a blog site;
managing blog information without requiring a connection to the blog site, the blog information being information about the blog site and the content;
logging-in to the blog site via a target device, using the blog information; and
uploading the content to the blog site based on the blog information.

30. The method of claim 29, wherein the blog information comprises a type of the content, a size of the content, a significance of the content, a privacy setting of the content, a menu title, user information, device information, and/or information about the blog site.

31. The method of claim 29, further comprising automatically logging-out of the blog site when the content is uploaded.

32. The method of claim 29, further comprising:
collecting the blog information from the user input and/or from a server providing the blog site.
